(19) United States
(12) Patent Application Publication
(10) Pub. No.: US 2026/0077646 A1
(43) Pub. Date: Mar. 19, 2026

(54) All-Terrain Vehicle

(71) Applicant: Zhejiang CFMOTO Power Co., Ltd., Hangzhou (CN)

(72) Inventors: Wenbing Duan, Hangzhou (CN); Xiliang Cai, Hangzhou (CN); Lei Xie, Hangzhou (CN)

(21) Appl. No.: 19/316,702

(22) Filed: Sep. 2, 2025

(30) Foreign Application Priority Data
Sep. 14, 2024 (CN) 202411299358.9
Mar. 28, 2025 (CN) 202510399191.1
Mar. 28, 2025 (CN) 202520578069.6

(51) Int. Cl. B60K 17/34; B60K 5/04; B60K 15/063; B60K 17/16; B60K 17/22; F02B 75/18; F02B 75/20

(52) U.S. Cl. CPC B60K 17/34; B60K 5/04; B60K 15/063; B60K 17/16; B60K 17/22; F02B 75/20; F02B 2075/1812

(57) ABSTRACT

An off-road vehicle includes a frame, a side-by-side seating area, a plurality of wheels, a prime mover assembly, and a drive train. The engine has three cylinders driving a transversely-extending crankshaft, with a left-most cylinder at least partially left of the longitudinal midplane and a right-most cylinder at least partially right of the longitudinal midplane. Neither the main drive shaft nor any other of the drive line components delivering torque extend under any of the plurality of cylinders of the engine. A majority of length of the main drive shaft is located on an opposite side of the longitudinal midplane as the engine centroid. The engine is tilted to define a receiving space over or under a portion of the engine, and at least part of the gear assembly is received in the receiving space, with a turbocharger over the gear assembly.

### RELATED APPLICATION INFORMATION

The present application claims the benefits of priority to Chinese Patent Application No. 202411299358.9, filed with the Chinese Patent Office on Sep. 14, 2024, Chinese Patent Application No. 202520578069.6, filed with the Chinese Patent Office on Mar. 28, 2025, and Chinese Patent Application No. 202510399191.1, filed with the Chinese Patent Office on Mar. 28, 2025. The entire contents of the above-referenced applications are incorporated herein by reference.

### FIELD OF THE DISCLOSURE

The present application relates to the field of vehicles, and particularly to an off-road vehicle.

### BACKGROUND OF THE DISCLOSURE

Off-road vehicles can travel on a wide variety of terrains, with many uses for work, recreation, competitive, and freight transportation. Off-road vehicles include SSVs (Side by Side Vehicles) and UTVs (Utility Terrain Vehicles or Utility Task Vehicles). Most off-road vehicles have high requirements for compactness of the prime mover assembly within their internal structure. Therefore, the problem of how to improve the compactness of the prime mover assembly within the entire vehicle urgently needs to be solved.

### SUMMARY OF THE INVENTION

In order to address the above shortcomings of existing off-road vehicles, the present invention provides an off-road vehicle with a compact layout of the prime mover assembly and related components.

To achieve the above objectives, the present application adopts the following technical solution.

An off-road vehicle includes a frame, a side-by-side seating area, a plurality of wheels, a prime mover assembly, and a drive train. The side-by-side seating area is supported by the frame. The plurality of wheels support the frame and include at least two front wheels and at least two rear wheels. The frame and the plurality of wheels defining a longitudinal mid-plane of the off-road vehicle. The prime mover assembly is supported by the frame includes an engine, a continuously variable transmission (CVT), and a gear assembly. The engine has a plurality of cylinders driving a transversely-extending crankshaft. The CVT is connected to the engine and receives torque from the crankshaft. The gear assembly is connected to the CVT and receives torque from the CVT. The drive train includes a front differential, a rear differential and one or more drive line components delivering torque longitudinally from the gear assembly to a further of the front differential and the rear differential. The front differential extends across the longitudinal mid-plane at least partially forward of the engine, and is able to provide torque to the front wheels for locomotion of the off-road vehicle. The rear differential extends across the longitudinal mid-plane at least partially rearward of the engine, and is able to provide torque to the rear wheels for locomotion of the off-road vehicle. The drive line components deliver torque longitudinally from the gear assembly to a further of the front differential and the rear differential. The drive line components include a main drive shaft.

In one aspect, a left-most cylinder extends at least partially on a left side of the longitudinal midplane and a right-most cylinder extends at least partially on a right side of the longitudinal midplane. Neither the main drive shaft nor any other of the drive line components delivering torque extend under any of the plurality of cylinders of the engine.

In another aspect, the engine has an engine centroid (and center of mass) disposed on a first left or right side of the longitudinal midplane. A majority of length of the main drive shaft is located on a second side of the longitudinal midplane opposite the first side of the longitudinal midplane.

In another aspect, the engine has three cylinders. The three cylinders of the engine are tilted to define a rear receiving space under a portion of the engine, and at least part of the gear assembly is received in the rear receiving space. The CVT is entirely on one side of the longitudinal midplane. A majority of length of the main drive shaft is located on that side of the longitudinal midplane, and the main drive shaft extends under the side-by-side seating area. A turbocharger is positioned at least partially over the gear assembly and behind the engine.

### BRIEF DESCRIPTION OF THE DRAWINGS

FIG. 1 is a right side view of an off-road vehicle in accordance with the present invention, without showing the seats or the steering wheel;

FIG. 2 is a front left perspective view of the frame, power train, intake and exhaust of the off-road vehicle of FIG. 1;

FIG. 3 is a rear left perspective view of the frame, power train, intake and exhaust of the off-road vehicle of FIGS. 1 and 2, without showing the rear wheels;

FIG. 4 is a rear right perspective view of the prime mover assembly, intake and exhaust components of FIGS. 2 and 3, showing only a portion of the drive train;

FIG. 5 is a right side view of the prime mover assembly, intake and exhaust components of FIGS. 2-4, showing only a portion of the drive train

FIG. 6 is a rear left perspective view of the prime mover assembly of FIGS. 2-5, showing only a portion of the drive train;

FIG. 7 is a bottom perspective view of the prime mover assembly and drive train portion of FIG. 6 without showing the rear half shafts;

FIG. 8 is a bottom perspective view of the power train, intake and exhaust of FIGS. 2-4;

FIG. 9 is a plan view of the prime mover assembly, drive train and fuel system of the off-road vehicle of FIG. 1;

FIG. 10 is a plan view of the prime mover assembly of FIGS. 2-9 in partial cross-section through the CVT;

FIG. 11 is a cross-sectional view through the CVT, taken along cut lines 11-11 of FIG. 10;

FIG. 12 is a side view of an alternative prime mover assembly for use in the off-road vehicle of FIG. 1;

FIG. 13 is a plan view of a second alternative prime mover assembly, drive train and fuel system for use in the off-road vehicle of FIG. 1;

FIG. 14 is a plan view of a third alternative prime mover assembly, drive train and fuel system for use in the off-road vehicle of FIG. 1;

FIG. 15 is an enlarged plan view of a portion of FIG. 14;

FIG. 16 is a plan view of a fourth alternative prime mover assembly, drive train and fuel system for use in the off-road vehicle of FIG. 1;

### DETAILED DESCRIPTION

For better understanding of the above objects, features and advantages of the present invention, embodiments of the present disclosure will be described in detail below with reference to the accompanying drawings.

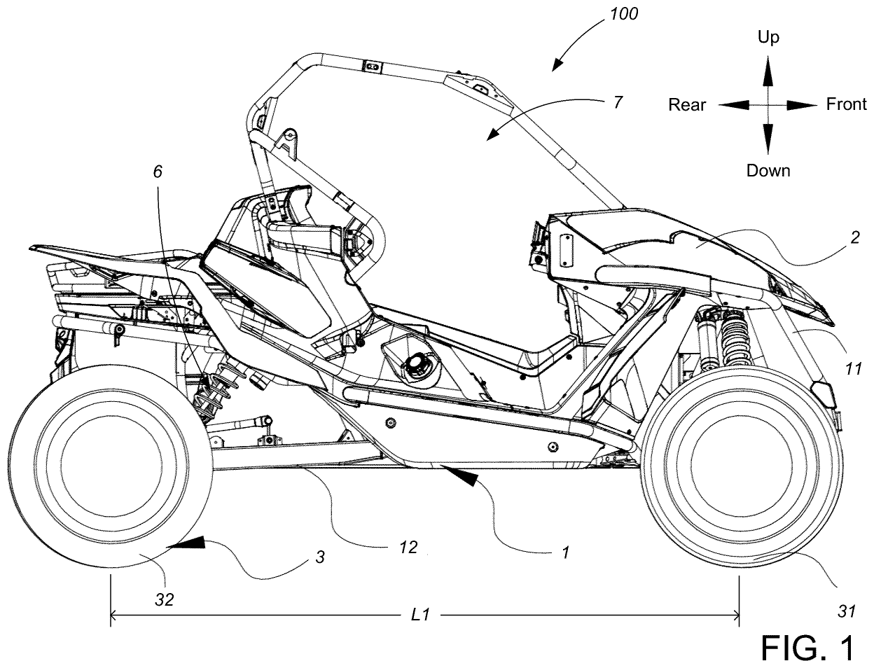

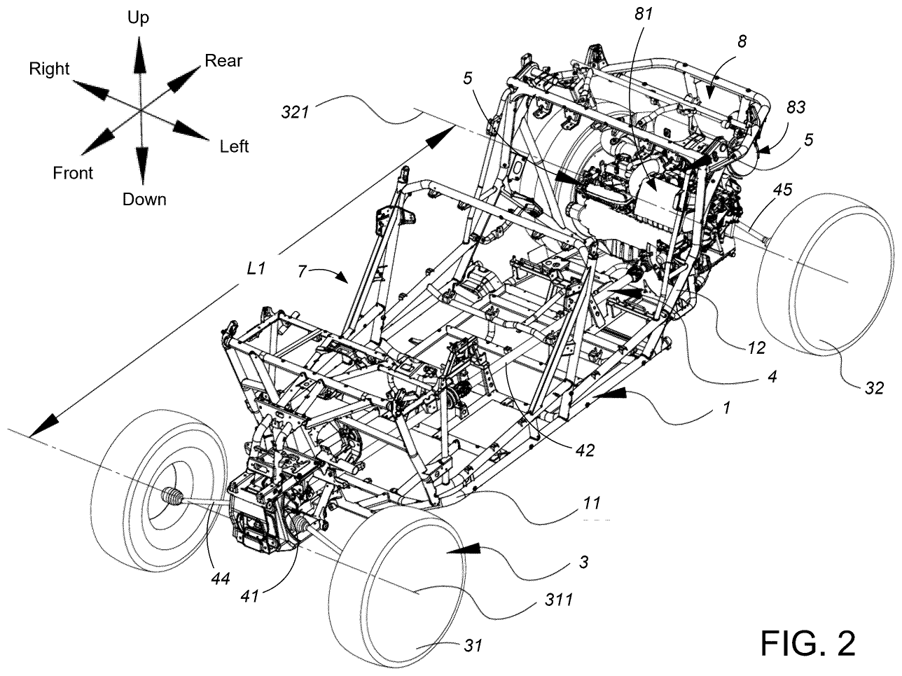

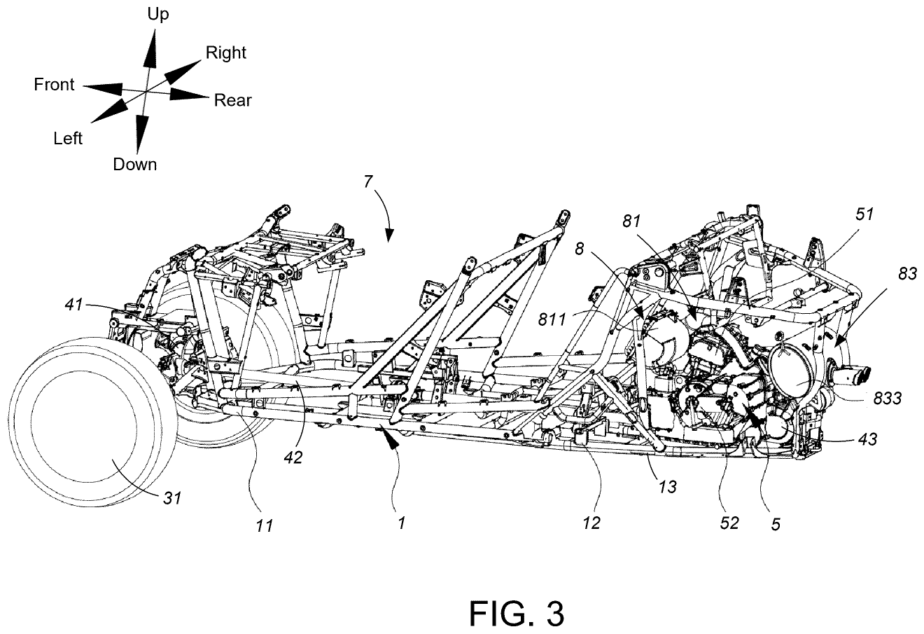

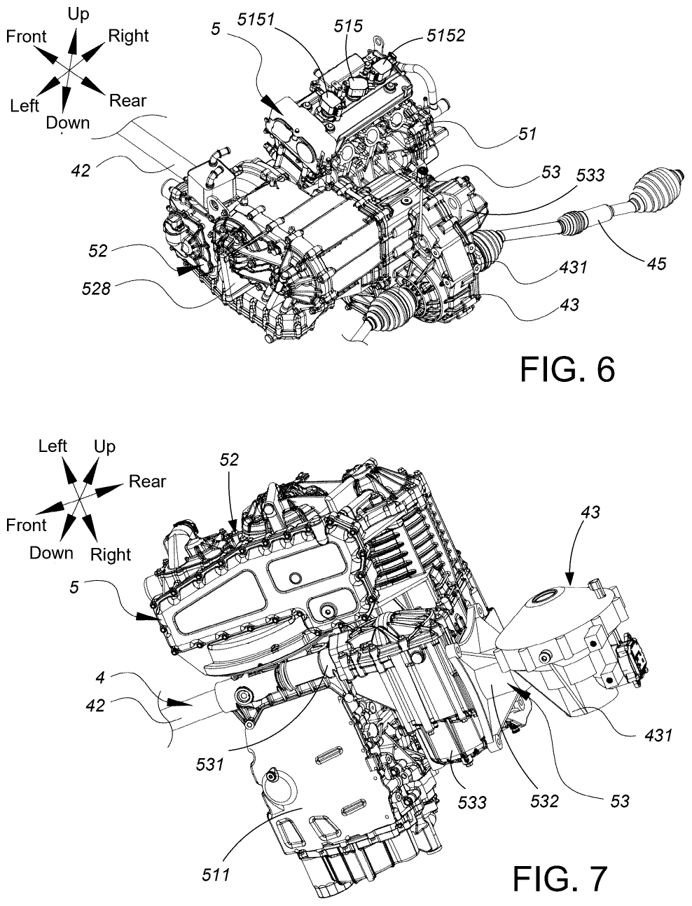

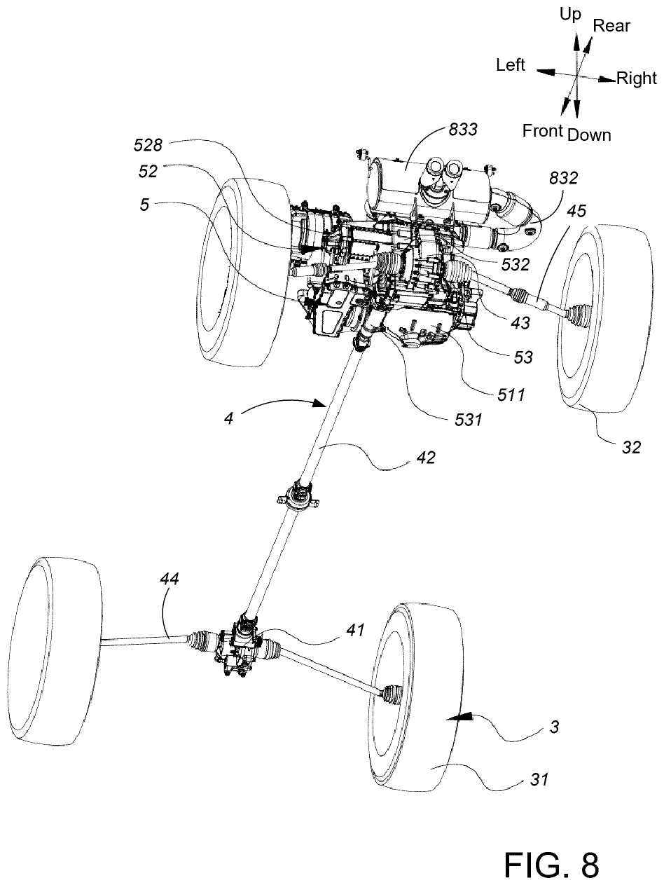

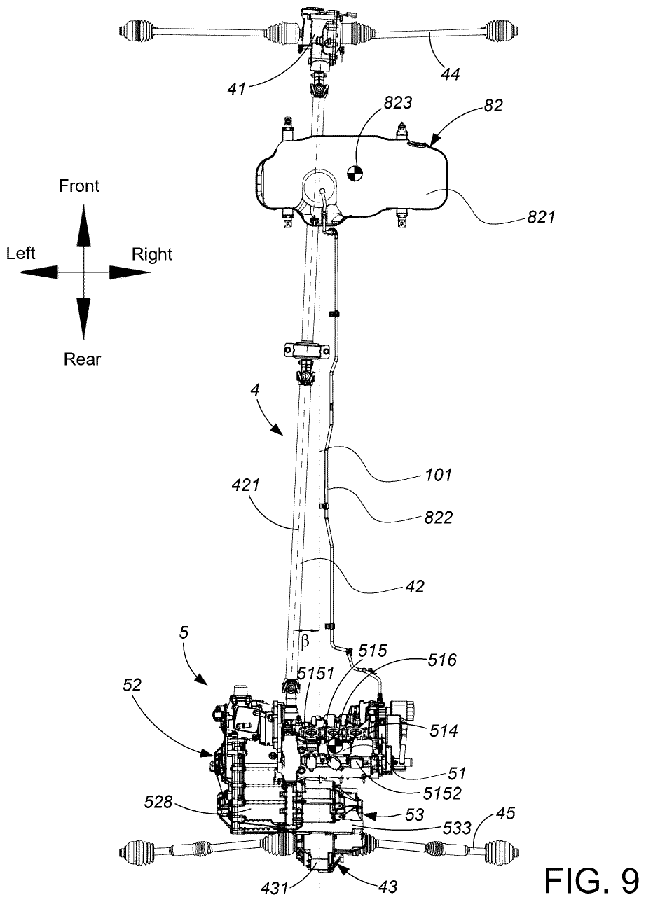

As shown in FIGS. 1 and 2, an off-road vehicle 100 includes a frame 1, a vehicle cover 2, and a power train including a plurality of wheels 3, a drive train 4, and a prime mover assembly 5. The vehicle cover 2 is connected to the frame 1 and at least partially covers the frame 1. The plurality of wheels 3 are connected to a suspension system 6 which supports the frame 1. The prime mover assembly 5 includes an engine 51 supported by frame 1 for generating torque which is transmitted to the plurality of wheels 3 for locomotion of the off-road vehicle 100. The drive train 4 is mounted on the frame 1 and is used to transmit torque generated by the prime mover assembly 5 to the plurality of wheels 3, driving the plurality of wheels 3 to move. The frame 1 includes a front frame 11 and a rear frame 12. The plurality of wheels 3 include at least a pair of front wheels 31 and a pair of rear wheels 32, with the pair of front wheels 31 at least partially below the front frame 11 and the pair of rear wheels 32 at least partially below the rear frame 12. For better understanding the technical solution of the present application, directions are taken with the vehicle 100 assumed to be on flat ground, and the directions of left, right, front, rear, up, and down as used in the description are shown in FIGS. 1-16.

The off-road vehicle 100 is a side-by-side off-road vehicle (SSV) having a cabin area 7 with side-by-side seating for a driver next to possibly one or more passengers. When the off-road vehicle 100 is traveling straight forward, the front wheels 31 rotate generally (i.e., subject to any camber or toe-in) about a front wheel axis 311, and the rear wheels 32 rotate generally about a rear wheel axis 321. The front wheel axis 311 is parallel to the rear wheel axis 321, and a wheelbase distance L1 measured longitudinally from the front wheel axis 311 to the rear wheel axis 321 is preferably in the range from 2060 mm to 2300 mm, such that the off-road vehicle 100 is more compact compared to the vast majority of on-road passenger vehicles. Due to the compactness of the off-road vehicle 100, the interior space of the off-road vehicle 100 and the space for installing components are relatively small, so the components need to be arranged as compactly as possible.

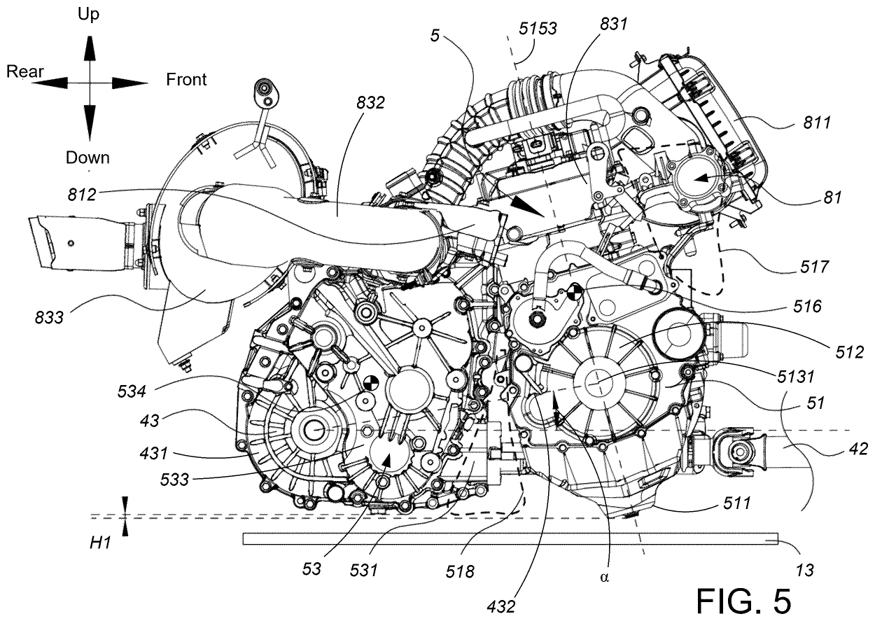

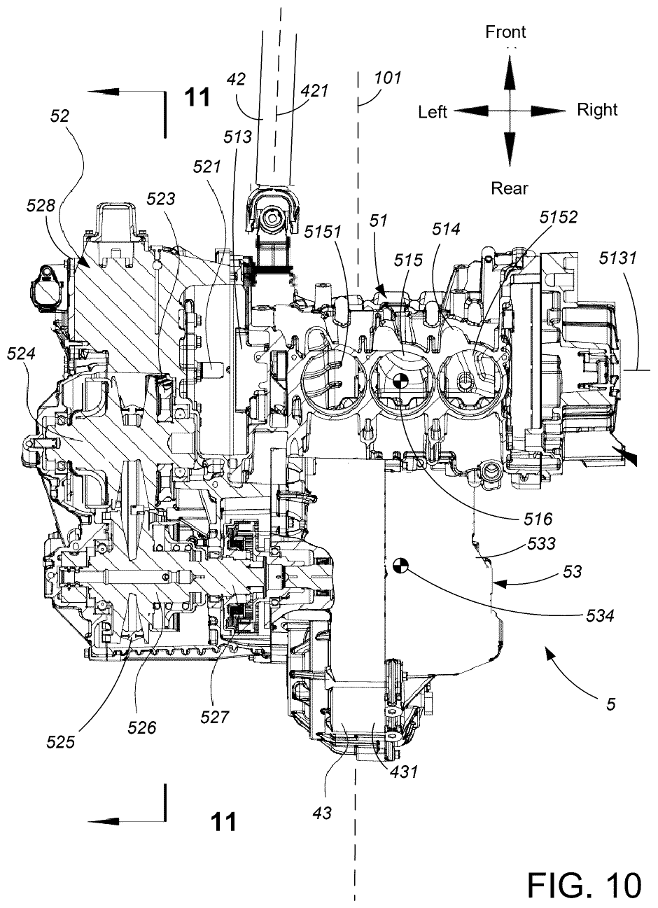

The engine 51 is an internal combustion engine which typically includes (from bottom to top, as called out in at least in FIG. 5 or FIG. 10) an oil pan 511, a crankcase 512 which in part houses a crankshaft 513, a cylinder block 514 defining multiple cylinders 515, pistons (not shown, one for each cylinder 515), a cylinder head with spark plugs (not shown), and a cylinder head cover (not individually called out), and makes up a significant portion of the weight of the off-road vehicle 100. The engine 51 is positioned at least partially within the wheelbase distance L1, where the engine 51 also takes up significant space within the off-road vehicle 100 and under the vehicle cover 2. In addition, the engine 51 is preferably tilted, to help reduce the longitudinal and vertical space occupied by the entire prime mover assembly 5, and such tilting also modifies spaces for receiving various components, thereby reducing the overall size and achieving a compact layout of the entire vehicle 100.

A longitudinal mid-plane 101, called out in FIGS. 9 and 10, is defined as a vertical plane perpendicular to the axes 311, 321 and including a mid-point of the frame 1 in the width direction. The plurality of cylinders 515 defined in the cylinder block 514 are arranged transversely so as to drive a transversely-extending crankshaft 513, with the preferred embodiment having three cylinders 515. The left-most cylinder 5151 extends at least partially on the left side of the longitudinal midplane 101. The right-most cylinder 5152 extends at least partially on the right side of the longitudinal midplane 101. In other words, the collection of cylinders 515 of the transversely oriented engine 51 extends across the longitudinal midplane 101. By orienting the engine 51 transversely, the engine 51 can occupy less length in the vehicle 100. By having the collection of cylinders 515 of the transversely oriented engine 51 extend across the longitudinal midplane 101, the center of mass 516 of the engine 51 is close to the longitudinal midplane 101 for better handling of the off-road vehicle 100, rather than be positioned off-balance too far to the right or left in the off-road vehicle 100.

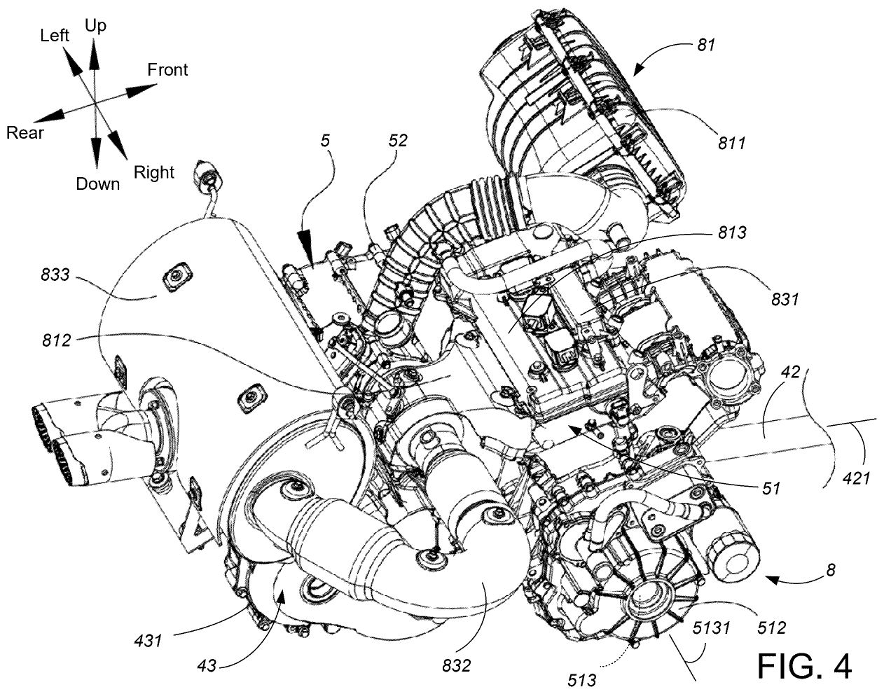

Several internal combustion peripheral systems 8 are provided for the internal combustion engine 51, including an air intake system 81, a fuel system 82, and an exhaust system 83. As called out in FIGS. 4 and 5, the air intake system 81 includes an air filter 811, a turbocharger 812, a throttle valve (not shown) and an intake manifold 813. The air filter 811 is preferably arranged in front of the engine 51. The turbocharger 812 is preferably positioned behind the engine 51. As called out in FIG. 9, the fuel system 82 includes a fuel tank 821 and a fuel line 822, as well as either a carburetor (not shown) or fuel injectors (not shown), to mix the fuel with air from the air intake system 81 before the fuel-air mixture enters the cylinders 515. As called out in FIGS. 4 and 5, the exhaust system 83 includes an exhaust manifold 831, an exhaust duct 832 and a muffler 833. The muffler 833 is preferably arranged behind the engine 51, with the muffler 833 oriented transversely and extending across the longitudinal midplane 101.

In addition to the engine 51, the prime mover assembly 5 includes a variable speed assembly consisting of a continuously variable transmission (CVT) 52 and a gear assembly 53. The engine 51, the CVT 52, and the gear assembly 53 are connected to transmit torque in sequence, with torque generated by the engine 51 transferred through the CVT 52 and ultimately output by the gear assembly 53 to the drive train 4.

The off-road vehicle 100 has a four-wheel drive mode, and the gear assembly 53 preferably has two outputs, namely a front output 531 (called out in FIG. 5) and a rear output 532 (called out in FIG. 7). As called out at least in FIG. 9, the drive train 4 includes a front differential 41, a main drive shaft 42, and a rear differential 43. The front differential 41 is mounted on the front frame 11 and is connected to the front wheels 31 through two front half shafts 44. The rear differential 43 is mounted on the rear frame 12 and is connected to the rear wheels 32 through two rear half shafts 45. In the four-wheel drive mode, the front differential 41 delivers torque to the front half shafts 44 and the rear differential 42 delivers torque to the rear half shafts 45. The front differential 41 and the rear differential 43 are each positioned so the longitudinal midplane 101 extends through both, preferably with the longitudinal midplane 101 bisecting the front differential 41 and bisecting the rear differential 43, to better provide balanced torque on the right and left sides of the off-road vehicle 100. The main drive shaft 42 extends primarily longitudinally, delivering torque to one of the front differential 41 and the rear differential 43, preferably connected to the front output 531 of the gear assembly 53 and delivering torque to the front differential 41. Thus, the preferred embodiments position the prime mover assembly 5 behind the cabin area 7, with the main drive shaft 42 being a front drive shaft which extends under the cabin area 7. In the first three preferred embodiments, a housing 431 of the rear differential 43 is directly attached to or integrally formed with a housing 533 of the gear assembly 53. In the last two preferred embodiments (FIGS. 14-16), the rear output 532 delivers torque to the rear differential 43 through a rear drive shaft 46. The gear assembly 53 may include a reduction gear set.

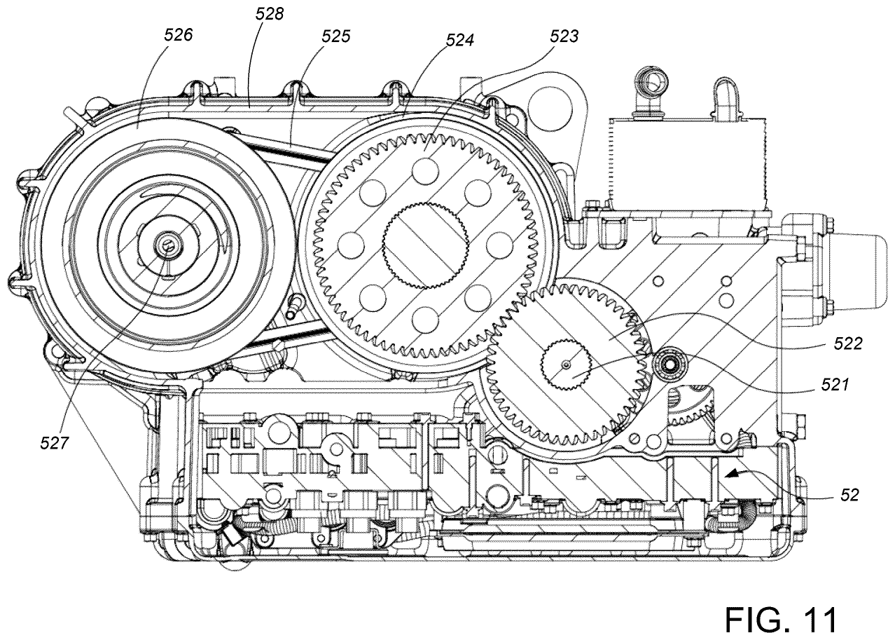

The CVT 52 is positioned to the left or right of the engine 51, preferably with the entirety of the CVT 52 on the opposite right or left side of the longitudinal midplane 101 than the centroid 516 of the engine 51. As called out in FIGS. 10 and 11, the CVT 52 preferably includes a CVT input shaft 521, a CVT input gear 522, a driving gear 523, a driving pulley 524, a CVT belt 525, a driven pulley 526 and a CVT output shaft 527 all within a CVT housing 528. The CVT input shaft 521 is connected to the crankshaft 513 of the engine 51, preferably through a spline (not shown) to achieve torque transmission. The CVT input gear 522 is coaxially fixed to the CVT input shaft 521 and meshed with the driving gear 523. One side of the driving pulley 524 is fixed with the driving gear 523 to transmit the torque of the CVT input shaft 521 to the driving pulley 524. The CVT belt 525 is entrained about both the driving pulley 524 and the driven pulley 526 at variable diameters on each, so the driving pulley 524 transmits torque to the driven pulley 526 while the rotational speed of the driven pulley 526 can change relative to the rotational speed of the driving pulley 524. In some embodiments, the CVT belt 525 is a steel belt, which has the advantages of being lightweight, small in size, and simple. In other embodiments, the CVT belt 525 is a rubber belt, which is lower in cost. In still other embodiment, the CVT belt 525 is replaced by a steel chain, which has better transmission efficiency and high load-bearing capacity. The CVT output shaft 527 is coaxially fixed to the driven pulley 526, and is coupled to the input end of the gear assembly 53 in a transmission mode such as through a clutch (not shown) when the off-road vehicle 100 is in gear (other than Park or Neutral). The CVT housing 528 is fixedly connected to the cylinder block 514 of the engine 51. In some alternative embodiments, the housing of the CVT 52 and the housing of the gear assembly 53 are integrally formed.

The preferred side view layout of the prime mover assembly 5 is best shown in FIG. 5. The cylinders 515 define cylinder center lines 5153 which are sloped relative to vertical, preferably downwardly and forwardly. The tilt of the engine 51 can reduce the vertical height of the engine 51 as compared to an upright engine, thereby achieving a more compact off-road vehicle 100. The tilt of the engine 51 also allows a front receiving space 517 and a rear receiving space 518 to be defined relative to the engine 51, which receiving spaces 517, 518 are vertically over or under a portion of the engine 51 but higher than the bottom (oil pan 511) of the engine 51 and lower than the top (cylinder head cover) of the engine 51. As used herein, the positional terms “over” and “under” indicate that the components at least partially overlap with each other in plan view when looking vertically, rather than just being at a higher or lower elevation. Both smaller volume components (such as electrical components, fuel system components, cooling system components, lubrication system components, etc.) and portions of larger volume components (such as portions of the gear assembly 53, portions of motors, etc.) can be positioned within either the front receiving space 517 or the rear receiving space 518.

In the preferred embodiment, the centroid 534 of the gear assembly 53 is positioned behind and lower than the engine centroid 516, on the same right or left side of the longitudinal midplane 101 as the engine centroid 516. A vertical distance H1 between the lowest point of the engine 51 and the lowest point of gear assembly 53 is preferably in the range from 0 to 50 mm, more preferably in the range from 0 to 20 mm, and most preferably in the range from 0 mm to 8 mm. A smaller value for the vertical distance H1 can facilitate installation of the engine 51 and gear assembly 53 on a bottom 13 of the frame 1. A low positioning of the gear assembly 53 also allows for positioning of components above the gear assembly 53 while still lower than the top of the engine 51. For instance, the turbocharger 812 is preferably positioned at least partially over the gear assembly 53, and the exhaust duct 832 preferably runs at least partially over the gear assembly 53.

The crankshaft 513 has a transversely extending crankshaft axis 5131 which preferably intersects the cylinder center lines 5153. A rear differential slope line 432 is defined to run from a centerline of the rear differential outputs (i.e., where the rear differential 43 provides torque to the rear half shafts 45) to the crankshaft axis 5131. The rear differential slope line 432 is preferably at a rear differential slope line angle α in the range from 6 to 11° to horizontal, and more preferably in the range from 8 to 10° to horizontal. Values for the rear differential slope line angle α within these preferred ranges can make the height difference H1 between the gear assembly 53 and the engine 51 smaller, and the overall vertical space occupied by prime mover assembly 5 can be reduced.

The preferred plan view layout of the prime mover assembly 5, drive train 4 and fuel system 82 of the off-road vehicle 100 is best understood with reference to FIG. 9. In this embodiment, the engine 51 is positioned in front of and adjacent to the gear assembly 53. The gear assembly 53 utilizes space left in the front-rear direction by the transverse layout of the engine 51, thereby enabling the entire prime mover assembly 5 to have better space occupancy and allowing a shorter wheelbase L1 of the off-road vehicle 100. The longitudinal midplane 101 extends through the engine 51, in this embodiment just to the right of the left-most cylinder 5151. The housing 431 of the rear differential 43 in this embodiment is directly connected to the housing 533 of the gear assembly 53, with the housing 431 of the rear differential 43 preferably bisecting the longitudinal midplane 101. The CVT 52 in this embodiment is positioned to the left of the engine 51 and to the left of the gear assembly 53, entirely to the left of the longitudinal midplane 101.

The main drive shaft 42 is coupled to the front output 531 of the gear assembly 53 at a location that is further left than the longitudinal midplane 101 and further left than the entirety of the left-most cylinder 5151. As such, none of the drive line components delivering torque extend under any of the plurality of cylinders 515 of the engine 51. By not positioning the main drive shaft 42 directly under any of the cylinders 515 of the engine 51, the combined height occupied by the engine 51 and the main drive shaft 42 is reduced. If not all of the main drive shaft 42, at least a majority of the length of the main drive shaft 42 is on the opposite side of the longitudinal midplane 101 as the centroid 516 of the engine 51.

In plan view, the rotation axis 421 of the main drive shaft 42 is angularly displaced from the longitudinal midplane 101 by a drive shaft offset angle β to allow for the leftward positioning of the front output 531 of the gear assembly 53. The drive shaft offset angle β is preferably greater than 0° and less than 15°, more preferably less than 10°, more preferably less than 8°, and most preferably within the range of 2-3°. A drive shaft offset angle α of 2-3°allows the rotation axis 421 of the main drive shaft 42 to be 60-100 mm left of the longitudinal midplane 101 where it meets the front output 531 of the gear assembly 53, allowing sufficient sideways clearance of the main drive shaft 42 relative to the left-most cylinder 5151 that the main drive shaft 42 need not pass under the left-most cylinder 5151.

FIG. 9 also shows the preferred transverse and longitudinal positioning of the fuel tank 821. The fuel tank 821 is a component that, when full of fuel, is relatively heavy in the off-road vehicle 100. The fuel tank 821 is positioned longitudinally within the wheelbase L1, on the opposite side of the cabin area 7 as the prime mover assembly 5, i.e., with the preferred position of the prime mover assembly 5 being behind the cabin area 7, the fuel tank 821 is positioned forward of the cabin area 7. Positioning the fuel tank 821 on the opposite side of the cabin area 7 as the prime mover assembly 5 helps to balance the weight front to back. The fuel tank 821 preferably extends across the longitudinal midplane 101. In this embodiment, the centroid 823 (center of mass when the fuel tank 821 is full) of the fuel tank 821 is on the same side of the longitudinal midplane 101 as the centroid 516 of the engine 51, in this embodiment both to the right of the longitudinal midplane 101. This positioning helps to balance out the weight of the driver, who is seated on the left of the longitudinal midplane 101, particularly in driving situations where no passenger is present.

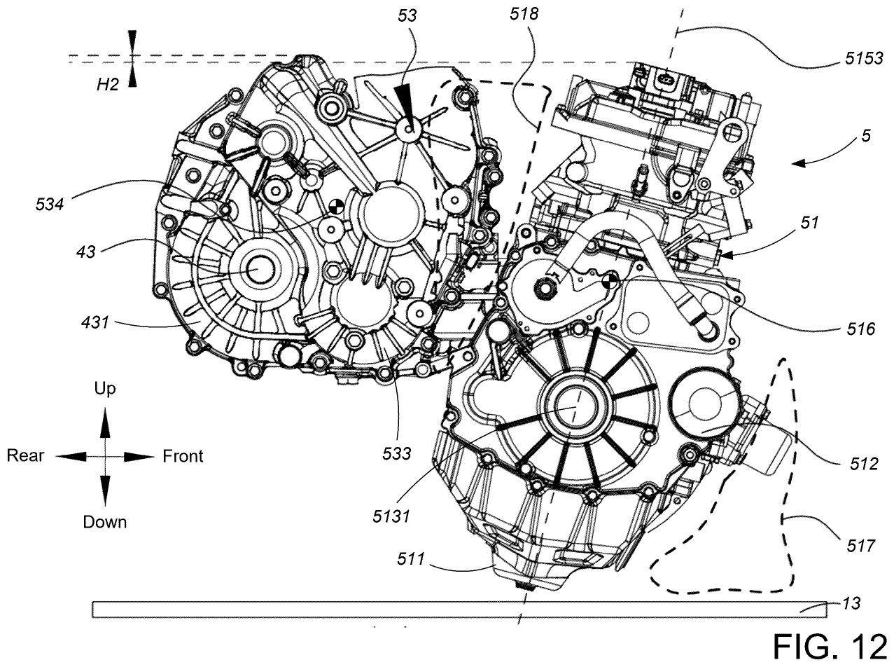

FIG. 12 shows an alternative embodiment in which the cylinder centerlines 5153 run downwardly and rearwardly, i.e., the top of the engine 51 is tilted forward rather than rearward. In this embodiment, the gear assembly centroid 534 is positioned behind and higher than the engine centroid 516, i.e. the gear assembly 53 is substantially positioned behind the engine 51 extending into the rear receiving space 518 partially over the bottom of the engine 51. A vertical distance H2 between the highest point (top of cylinder head cover) of the engine 51 and the highest point of gear assembly 53 is preferably in the range from 0 to 70 mm, more preferably in the range from 0 to 50 mm., and most preferably in the range from 0 to 4 mm. The small vertical distance H2 allows more of the gear assembly 53 to be received in the rear receiving space 518, and also make the top of the gear assembly 53 almost at the same level as the top of the engine 51 and reduce the vertical space occupied by the entire prime mover assembly 5.

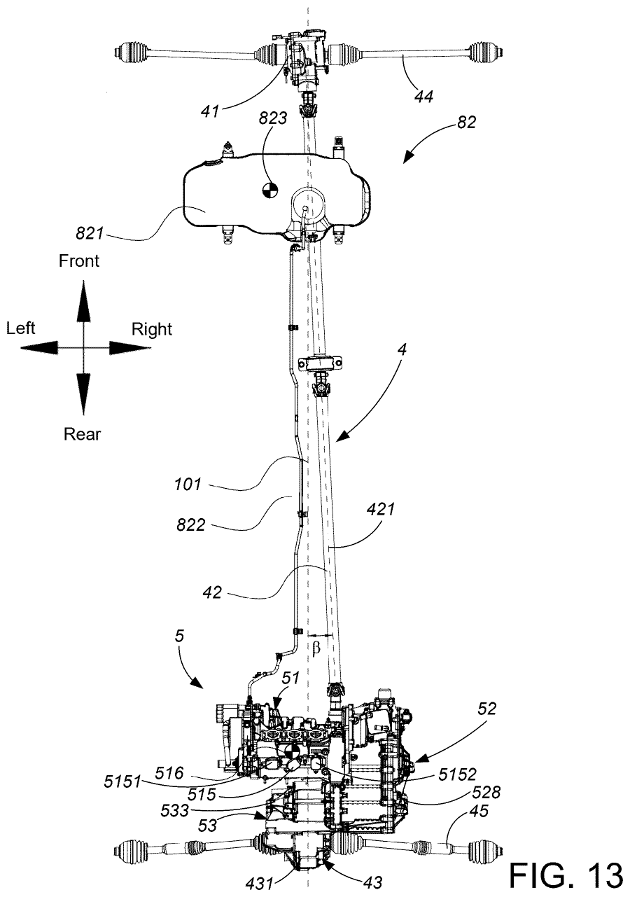

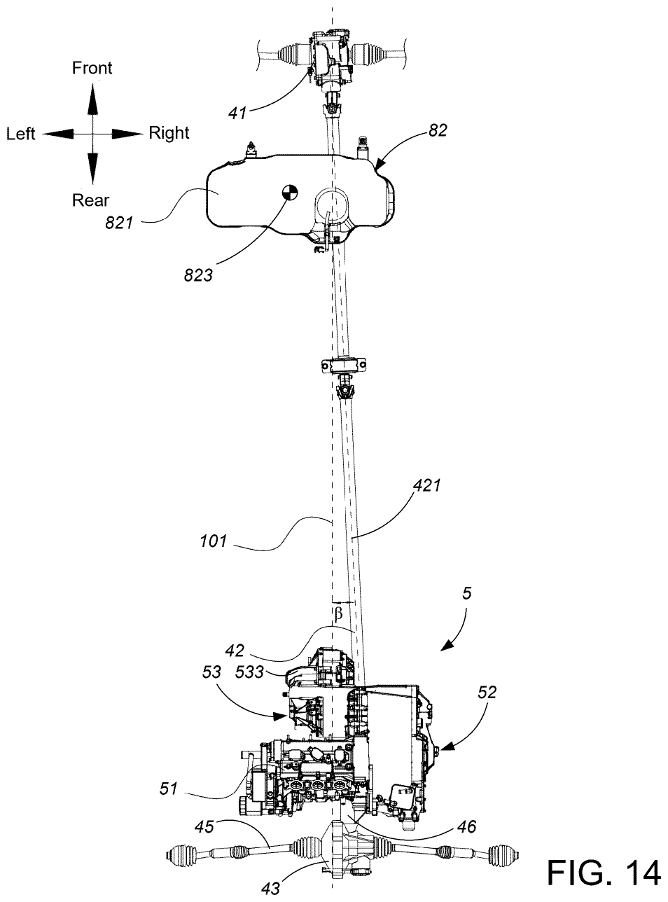

FIG. 13 shows an alternative embodiment in which the plan view layout of the engine 51, CVT 52, gear assembly 53, main drive shaft 42 and fuel tank 821 are right-to-left mirror images of the first embodiment. The embodiment of FIG. 13 is particularly beneficial when the all-terrain vehicle 100 is outfitted for countries in which the driver sits on the right side of the vehicle 100. Other embodiments (not shown) have the centroid 823 of the fuel tank 821 on the opposite side of the longitudinal midplane 101 as the centroid 516 of the engine 51, which can further improve the balance of the off-road vehicle 100 in the left-right direction, particularly helpful in situations where the driver and passenger have relatively equal weight.

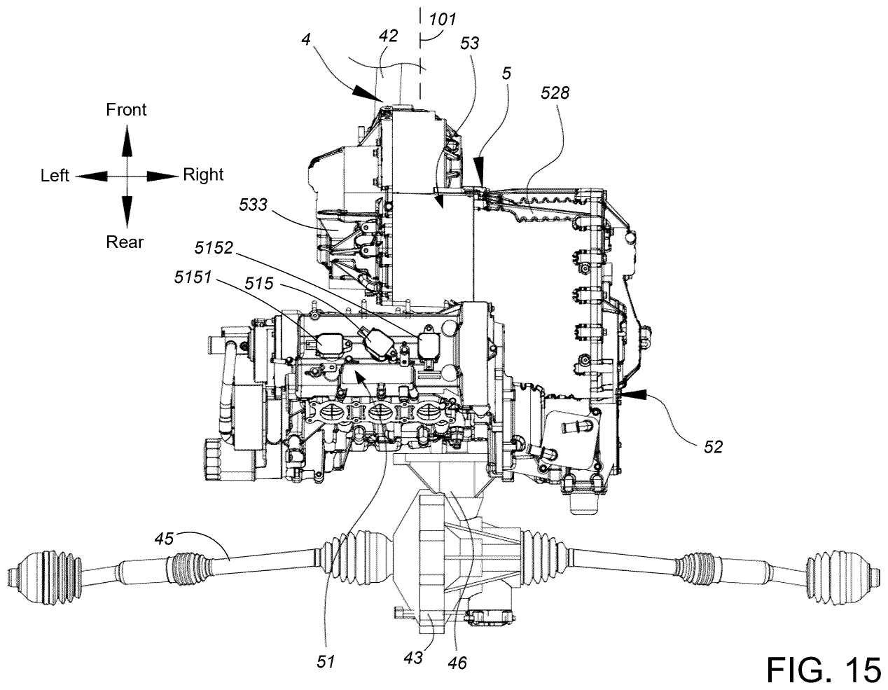

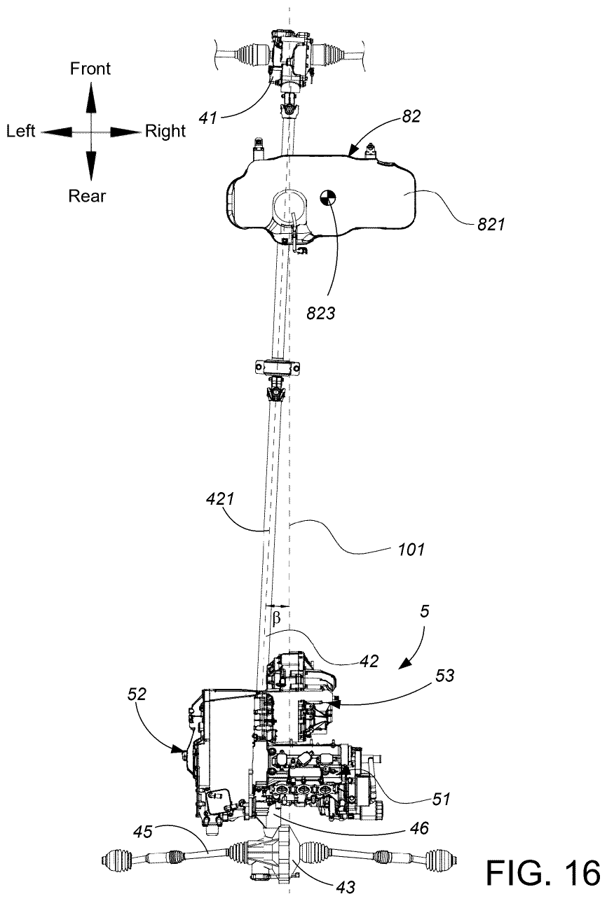

FIGS. 14-16 show two embodiments where the front to back layout of the prime mover assembly 5 is reversed relative to the earlier embodiments, namely, the gear assembly 53 is positioned forward of the engine 51. The engine 51 is still positioned within the wheelbase L1, just in front of the rear differential 43. In the embodiment of FIGS. 14 and 15, the CVT 52 is to the right of the engine 51 and gear assembly 53. In the embodiment of FIG. 16, the CVT 52 is to the left of the engine 51 and gear assembly 53.

Because the embodiments of FIGS. 14-16 place the engine 51 between the gear assembly 53 and the rear differential 43, the housing 431 of the rear differential 43 is no longer attached to the housing 533 of the gear assembly 53, but instead exists as a separately mounted component. A rear drive shaft 46 is used to transmit torque longitudinally from the gear assembly 53 rearwardly to the rear differential 43. So the rear drive shaft 46 does not extend under any of the cylinders 515 of the engine 51, the rear drive shaft 46 is substantially offset from the longitudinal midplane 101, on the opposite side of the longitudinal midplane 101 from the centroid 516 of the engine 51. The preferred embodiment spaces the rear drive shaft axis from 60 to 100 mm from the longitudinal midplane 101. An additional gear or set of gears (not shown) may be positioned between the rear drive shaft 46 and the crown gear (not shown) of the rear differential 43 to traverse the lateral offset of the rear drive shaft 46 from the center of the rear differential 43 on the longitudinal midplane 101.

It should be noted that for those skilled in the art, improvements or transformations can be made based on the above description, and all such improvements and transformations should fall within the scope of protection of the claims attached to the present application.

1. An off-road vehicle comprising:
a frame;
a side-by-side seating area supported by the frame;
a plurality of wheels supporting the frame, the plurality of wheels including at least two front wheels and at least two rear wheels, the frame and the plurality of wheels defining a longitudinal mid-plane of the off-road vehicle;
an engine supported by the frame, the engine comprising a plurality of cylinders driving a transversely-extending crankshaft, with at least a left-most cylinder extending at least partially on a left side of the longitudinal midplane and a right-most cylinder extending at least partially on a right side of the longitudinal midplane;
a continuously variable transmission (CVT) connected to the engine and receiving torque from the crankshaft;
a gear assembly connected to the CVT and receiving torque from the CVT; and
a drive train supported by the frame and delivering torque from the gear assembly to the front and rear wheels, the drive train comprising:
a front differential extending across the longitudinal mid-plane and able to provide torque to the front wheels for locomotion of the off-road vehicle, the front differential being at least partially forward of the engine;
a rear differential extending across the longitudinal mid-plane and able to provide torque to the rear wheels for locomotion of the off-road vehicle, the rear differential being at least partially rearward of the engine; and
one or more drive line components delivering torque longitudinally from the gear assembly to a further of the front differential and the rear differential, the drive line components including a main drive shaft;
wherein neither the main drive shaft nor any other of the drive line components delivering torque extend under any of the plurality of cylinders of the engine.

2. The off-road vehicle of claim 1, a majority of length of the main drive shaft is located on a first left or right side of the longitudinal midplane, and wherein at least two of the plurality of cylinders extend on a second side of the longitudinal midplane opposite the first side.

3. The off-road vehicle of claim 2, wherein the entirety of the CVT is on the first side of the longitudinal midplane.

4. The off-road vehicle of claim 3, further comprising a fuel tank supported by the frame, wherein a centroid of the fuel tank is located on the second side of the longitudinal midplane with the at least two of the plurality of cylinders being on the second side of the longitudinal midplane.

5. The off-road vehicle of claim 3, wherein the plurality of cylinders are three cylinders.

6. The off-road vehicle of claim 5, wherein the engine is in front of the gear assembly, and wherein the three cylinders of the engine tilt to define a rear receiving space over or under a portion of the engine, and the gear assembly is at least partially received in the rear receiving space.

7. The off-road vehicle of claim 6, wherein a vertical distance from a lowest point of the engine to a lowest point of the gear assembly is in a range from 0 to 50 mm.

8. The off-road vehicle of claim 6, further comprising a turbocharger which is positioned at least partially over the gear assembly and behind the engine.

9. The off-road vehicle of claim 6, wherein the main drive shaft delivers torque to the front differential, and wherein a housing of the gear assembly is directly attached to a housing of the rear differential.

10. The off-road vehicle of claim 9, wherein the crankshaft defines a crankshaft axis, wherein the rear differential has outputs defining a rear differential output centerline, and wherein a rear differential slope line running from the rear differential output centerline to the crankshaft axis has a rear differential slope line angle in a range from 6 to 11° above horizontal.

11. The off-road vehicle of claim 1, wherein the gear assembly is in front of the engine, and wherein the drive line further comprises a rear drive shaft delivering torque from the gear assembly to the rear differential.

12. An off-road vehicle comprising:
a frame;
a side-by-side seating area supported by the frame;
a plurality of wheels supporting the frame, the plurality of wheels including at least two front wheels and at least two rear wheels, the frame and the plurality of wheels defining a longitudinal mid-plane of the off-road vehicle;
an engine supported by the frame, the engine comprising a plurality of cylinders driving a transversely-extending crankshaft, the engine having an engine centroid disposed on a first left or right side of the longitudinal midplane;
a continuously variable transmission (CVT) connected to the engine and receiving torque from the crankshaft;
a gear assembly connected to the CVT and receiving torque from the CVT; and
a drive train supported by the frame and delivering torque from the gear assembly to the front and rear wheels, the drive train comprising:
a front differential extending across the longitudinal mid-plane and able to provide torque to the front wheels for locomotion of the off-road vehicle, the front differential being at least partially forward of the engine;
a rear differential extending across the longitudinal mid-plane and able to provide torque to the rear wheels for locomotion of the off-road vehicle, the rear differential being at least partially rearward of the engine; and
one or more drive line components delivering torque longitudinally from the gear assembly to a further of the front differential and the rear differential, the drive line components including a main drive shaft;
wherein a majority of length of the main drive shaft is located on a second side of the longitudinal midplane opposite the first side of the longitudinal midplane.

13. The off-road vehicle of claim 12, wherein the entirety of the CVT is on the second side of the longitudinal midplane with the majority of length of the main drive shaft.

14. The off-road vehicle of claim 12, further comprising a fuel tank supported by the frame, wherein a centroid of the fuel tank is located on the first side of the longitudinal midplane with the engine centroid.

15. The off-road vehicle of claim 12, wherein the plurality of cylinders are three cylinders, one of the three cylinders extending on the second side of the longitudinal midplane.

16. The off-road vehicle of claim 12, wherein the engine is in front of the gear assembly, and wherein the plurality of cylinders of the engine tilt to define a rear receiving space over or under a portion of the engine, and the gear assembly is at least partially received in the rear receiving space.

17. The off-road vehicle of claim 12, wherein a vertical distance from a lowest point of the engine to a lowest point of the gear assembly is in a range from 0 to 50 mm.

18. The off-road vehicle of claim 12, wherein the engine is in front of the gear assembly, wherein the plurality of cylinders of the engine tilt to define a rear receiving space under a portion of the engine, the gear assembly being at least partially received in the rear receiving space, and wherein the off-road vehicle further comprises a turbocharger which is positioned at least partially over the gear assembly and behind the engine.

19. The off-road vehicle of claim 12, wherein the crankshaft defines a crankshaft axis, wherein the rear differential has outputs defining a rear differential output centerline, and wherein a rear differential slope line running from the rear differential output centerline to the crankshaft axis has a rear differential slope line angle in a range from 6 to 11° above horizontal.

20. An off-road vehicle comprising:
a frame;
a side-by-side seating area supported by the frame;
a plurality of wheels supporting the frame, the plurality of wheels including at least two front wheels and at least two rear wheels, the frame and the plurality of wheels defining a longitudinal mid-plane of the off-road vehicle;
an engine supported by the frame, the engine comprising three cylinders driving a transversely-extending crankshaft, the three cylinders of the engine being tilted to define a rear receiving space under a portion of the engine;
a continuously variable transmission (CVT) connected to the engine and receiving torque from the crankshaft, the CVT being entirely on a first right or left side of the longitudinal midplane;
a gear assembly connected to the CVT and receiving torque from the CVT, the gear assembly being positioned behind the engine, with at least part of the gear assembly being received in the rear receiving space;
a turbocharger which is positioned at least partially over the gear assembly and behind the engine; and
a drive train supported by the frame and delivering torque from the gear assembly to the front and rear wheels, the drive train comprising:
a front differential extending across the longitudinal mid-plane and able to provide torque to the front wheels for locomotion of the off-road vehicle, the front differential being at least partially forward of the engine;
a rear differential extending across the longitudinal mid-plane and able to provide torque to the rear wheels for locomotion of the off-road vehicle, the rear differential being at least partially rearward of the engine; and
one or more drive line components delivering torque longitudinally from the gear assembly to a further of the front differential and the rear differential, the drive line components including a main drive shaft, the main drive shaft extending under the side-by-side seating area, a majority of length of the main drive shaft being located on the first side of the longitudinal midplane.
